(19) United States
(12) Patent Application Publication
(10) Pub. No.: US 2010/0042814 A1
(43) Pub. Date: Feb. 18, 2010

(54) EXTENDED INSTRUCTION SET ARCHITECTURES

(76) Inventors: Saeid Tehrani, Farmington Hills, MI (US); Babak Makkinejad, Troy, MI (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/191,968

(22) Filed: Aug. 14, 2008

(51) Int. Cl. G06F 7/38

(52) U.S. Cl. 712/221

(57) ABSTRACT

An instruction set architecture includes a definition set of extended real values (e.g., computations or values that typically produce an IEEE NaN result) and a rules set of extended real value rules specifying values for one or more functions of one or more extended real values. Operations are performed on extended real values based at least partially on the extended real value rules. The instruction set architecture can be used, for example, to facilitate continued operations in a computer in case of errors relating to computations on or resulting in undefined values.

### TECHNICAL FIELD

This invention relates to processing data, and more particularly to processing real numbers with undefined real values.

### BACKGROUND

Instruction set architectures commonly used for computers are based on real numbers (e.g., rational numbers such as 1, 1.5, and 1/3, and irrational numbers such as the square root of 2) and traditional arithmetic axioms which define basic operations on real numbers. These axioms do not deal with operations involving undefined values. However, computations in modern computers can produce values outside the real number domain set. Currently, when the computations result in a value outside the set of real numbers, the computations may be terminated and an error message may be generated indicating an NaN (Not a Number) quantity has been produced.

### SUMMARY

In various implementations, an Extended Instruction Set Architecture may include a definition set of extended real values which include undefined values and a rules set to provide extended real value rules. Operations may be performed, for example, without interruption on extended real values based at least partially on the extended real value rules.

In one general aspect, a definition set may be stored that includes a plurality of extended real value definitions, where an extended real value definition includes a definition for at least one extended real value, and a rules set may be stored that includes a plurality of extended real value rules, where an extended real value rule specifies a value for a function of at least one of the extended real values. Mathematical operations may be performed at least partially based on the stored rules set.

Various implementations may include one or more of the following features. One or more of the defined extended real values may include positive infinity, negative infinity, unsigned infinity, a bounded undefined value, an unbounded undefined value, a positive bounded undefined value, a negative bounded undefined value, a positive unbounded undefined value, a negative unbounded undefined value, a complex value, an imaginary value, and/or a bounded undefined value excluding 0. The rules set may include values for trigonometric functions of at least one of the defined extended real values. The rules set may include values for logarithmic functions of at least one of the defined extended real values. The rules set may include values for power functions of at least one of the defined extended real values. The rules set may include values for at least one elementary function of at least one of the defined extended real values. Performing mathematical operations at least partially based on the stored rules set may produce a resulting value and the resulting value may be stored. The resulting value may include a real number. The resulting value may include an extended real value and a real number may be associated with the resulting value (e.g., in a computational device or system). The mathematical operations may include at least one first function that includes an operation on at least one extended real value and produces a first resulting value, and at least one second function that includes an operation on the first resulting value, where at least one of the extended real value rules is defined such that the second function operates on the first resulting value. The definition set and the rules set facilitate continued operations of a device after computations produce an extended real value.

In another general aspect, at least one extended real value is received and a definition set including a plurality of extended real value definitions is retrieved, where an extended real value definition includes a definition for at least one defined extended real value. One or more rules may be retrieved from a rules set, where the rules set includes a plurality of extended real value rules, and where an extended real value rule includes a value for a function of at least one of the extended real values. Mathematical operations may be performed at least partially based on the retrieved rules set.

Various implementations may include one or more of the following features. One or more of the defined extended real values may include at least one of positive infinity, negative infinity, unsigned infinity, a bounded undefined value, or an unbounded undefined value. The rules set may include at least one of values for trigonometric functions of one or more of the defined extended real values, values for logarithmic functions of one or more of the defined extended real values, values for power functions of one or more of the defined extended real values, or values for at least one elementary function of one or more of the defined extended real values. A number may be received and a determination may be made whether the received number is an extended real value based on at least one of the retrieved definitions in the definition set. Mathematical operations may be performed at least partially based on the retrieved rules set, if the value is an extended real value.

In one general aspect, a system for processing data includes a memory and a processor. A memory stores a definition set including a plurality of extended real value definitions, where an extended real value definition includes a definition for at least one defined extended real value. The memory also stores a rules set including a plurality of extended real value rules, where an extended real value rule includes a value for a function of at least one of the extended real values. The processor is adapted to performing mathematical operations at least partially based on the stored rules set.

Various implementations may include one or more of the following features. One or more of the defined extended real values may include at least one of positive infinity, negative infinity, unsigned infinity, a bounded undefined value, an unbounded undefined value, a positive bounded undefined value, a negative bounded undefined value, a positive unbounded undefined value, a negative unbounded undefined value, a complex value, an imaginary value, and/or a bounded undefined value excluding 0. The rules set may include at least one of values for trigonometric functions of at least one of the defined extended real values, values for logarithmic functions of at least one of the defined extended real values, values for power functions of at least one of the defined extended real values, values for at least one elementary function of at least one of the defined extended real values. Performing mathematical operations at least partially based on the stored rules set may produce a resulting value; and the memory may store the resulting value. The resulting value may include a real number. The resulting value may include an extended real value, and a real number may be associated with the resulting value.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates an example system for handling and processing extended real values.

FIGS. 2A-B illustrate an example process for handling and processing extended real values.

FIGS. 3A-B illustrate an example process for performing operations on quantities including extended real values.

FIG. 4 illustrates an example of communications between various components of an example system.

Like reference symbols in the various drawings indicate like elements.

### DETAILED DESCRIPTION

During operations of various systems (e.g., computers, handheld calculators, game stations, and devices used in laboratories and medicine), undefined values can be encountered. Designations of these typically undefined values can be added to set of already defined real numbers. Such designations may be referred to as an extended real values set. When these values are encountered, new rules set operations may be used to continue processing operations and/or to produce meaningful results. For example, rather than receiving an NaN error message as prescribed by the IEEE standards, if the operations are adapted to handle computations involving extended real values, useful results may be produced.

An instruction set architecture may include various instructions, such as control flow instructions (e.g., goto, if . . . goto, call, return), data instructions (e.g., move, input, output, load, store), logic instructions (e.g., and, or, not), and/or arithmetic instructions (e.g., add, subtract, multiply). This instruction set may be a part of a computer architecture related to programming, include native data types, instructions, registers, addressing modes, memory architecture, interrupt and exception handling, and/or external I/O. The instruction set may be a set of codes for a device that is implemented by a CPU.

In some implementations, the arithmetic instructions for a device may include instructions related to extended real values. The instructions may include definition sets and/or rules sets for extended real values. A definition set including multiple extended real value definitions may include definitions for one or more extended real value. Extended real values may include values, such as unsigned infinity, positive infinity (supremum), negative infinity (infimum), unbounded undefined values, bounded undefined values, positive bounded undefined values, negative bounded undefined values, positive unbounded undefined values, negative unbounded undefined values, complex values, imaginary values, bounded undefined values excluding 0, and/or other values that combine aspects of the above values. A bounded value is a result of an expression that does not produce infinity (e.g., an unknown value between −10 and 20). An unbounded undefined value is a result of an expression that may contain infinity, such as 0/0, 0̂0, 1̂∞, 0×∞, ∞/∞ and ∞̂0 which are unbounded undefined in the field of real numbers.

Bounded undefined values may be distinguished from computer variables. Variables are registers or memory locations in a system that contain numbers. The variable value may not be known before the operations, but will have a well defined value after the operation is completed. A bounded undefined value can be produced from an invalid operation or operations involving undefined values. For example, applying a bounded function (e.g. Cos function) that maps all real numbers to −1 and 1 to an undefined number (e.g., 0/0) will result in an undefined value whose range will still be between −1 and 1. Note that 0/0 results in an undefined number which may include infinity and thus is an unbounded undefined value.

In some implementations, extended real value definitions may include symbols or other representations for various extended real values.

Table 1 illustrates an example of a definition set that includes extended real value definitions. As illustrated, a definition set may include definitions for real numbers and extended real values. For example, the definition set may include definitions for real numbers such as 0, 1, a, b, etc. The definition set may also include definitions for extended real values such as ∞, Φ, and/or φ. As illustrated, φ, a bounded undefined value, may be any positive or negative number including zero as opposed to a, b, p, and n which are defined as known constants. In some implementations, the definition set may further include additional definitions (not included in Table 1) for other values, such as strictly positive bounded undefined values, strictly negative bounded undefined values, strictly positive unbounded undefined values, strictly negative unbounded undefined values, complex values (e.g., including both real and imaginary components), imaginary values, and/or bounded undefined values excluding 0. Other values can also be defined, such as a complex bounded undefined value excluding 0. Additional symbols could be used to represent such other values.

TABLE 1

| Symbol | Definition |
|---|---|
| 0 | Zero |
| 1 | One |
| a, b | An arbitrary non-zero constant (excluding infinity) |
| p | A real positive (non-zero) constant (excluding infinity) |
| n | A real negative (non-zero) constant (excluding infinity) |
| Φ | Unbounded Undefined Number (including 0 and +/−infinity) |
| φ | Bounded Undefined Number (including 0) |
| ∞ | Plus or minus infinity (the sign cannot be determined) |
| +∞ | Plus infinity |
| −∞ | Minus infinity |

The rules set may include various rules for extended real values. The extended real value rules may specify a value for a function that operates on at least one of the extended real values. For example, the rules may include specified values for functions, such as trigonometric functions (e.g., Sin, Cos, Tan, Arcsin, Arcos, Arctan, etc.), logarithmic functions (e.g., logarithms for a given base such as e), power functions including root of a real value (e.g., a function in which a real quantity is raised to an exponential real value), elementary functions (e.g., addition, subtraction, multiplication, division, integer root extraction), periodic functions (e.g., functions with a single or multiple periods), absolute value function, etc. Some examples of functions and elementary operations operating on extended real values are included in Tables 2 to 7 below (see Table 1 for definition of symbols used in the following tables). These relatively small number of rules can easily be stored in a computer internal or external memory. Note that these definitions are not limited to the functions described here. Moreover, in some implementations, the rules set may further include additional rules (not included in the tables below) for other values, such as strictly positive bounded undefined values, strictly negative bounded undefined values, strictly positive unbounded undefined values, strictly negative unbounded undefined values, complex values, imaginary values, bounded undefined numbers excluding 0, and/or other values. One reason for defining additional extended values, for example, is that bounded undefined values excluding 0 to the power of 0 is 1 whereas when it includes 0 it can be an unbounded undefined value. Thus, by adding more extended values, more accurate results can be obtained and/or more errors can be avoided or rectified. The rules in the rules set may specify values for functions performed using extended values, including combinations of such values with extended real values discussed above.

Table 2 illustrates an example rules set that includes rules for various functions on real numbers and extended real values. As illustrated, a rules set may include rules that specify values for a plurality of trigonometric functions, logarithmic functions, periodic functions, and/or any other function (e.g., absolute value function).

TABLE 2

| | Fn | sin(x) | cos(x) | tan(x) | Arcsin(x) | Arccos(x) | Arctan(x) | ln(x) | e\hat{ }x | \|x\| |
|---|---|---|---|---|---|---|---|---|---|---|
| A | 0 | 0 | 1 | 0 | 0 | π/2 | 0 | −∞ | 1 | 0 |
| | 1 | 0.84 | 0.54 | 1.56 | π/2 | 0 | π/4 | 0 | e | 1 |
| | p > 1 | sin(p) | cos(p) | tan(p) | φ | φ | Arctan(p) | ln(p) | e\hat{ }p | p |
| | p <= 1 | sin(p) | cos(p) | tan(p) | Arcsin(p) | Arccos(p) | Arctan(p) | ln(p) | e\hat{ }p | p |
| | n >= −1 | sin(n) | cos(n) | tan(n) | Arcsin(n) | Arccos(n) | Arctan(n) | φ | e\hat{ }n | −n |
| | n < −1 | sin(n) | cos(n) | tan(n) | φ | φ | Arctan(n) | φ | e\hat{ }n | −n |
| | Φ | φ | φ | Φ | φ | φ | φ | Φ | Φ | Φ |
| | φ | φ | φ | Φ | φ | φ | φ | Φ | φ | φ |
| | ∞ | φ | φ | Φ | φ | φ | +/−π/2 | Φ | Φ | +∞ |
| | +∞ | φ | φ | Φ | φ | φ | π/2 | +∞ | +∞ | +∞ |
| | −∞ | φ | φ | Φ | φ | φ | −π/2 | Φ | 0 | +∞ |

Table 3 illustrates an example rules set or a portion thereof. As illustrated, the rules set may include values for an elementary operation such as addition.

TABLE 3

| | | A | | | | | | | |
|---|---|---|---|---|---|---|---|---|---|
| | A + B | 0 | 1 | a | Φ | φ | ∞ | +∞ | −∞ |
| B | 0 | 0 | 1 | a | Φ | φ | ∞ | +∞ | −∞ |
| | 1 | 1 | 2 | a + 1 | Φ | φ | ∞ | +∞ | −∞ |
| | b | b | b + 1 | a + b | Φ | φ | ∞ | +∞ | −∞ |
| | Φ | Φ | Φ | Φ | Φ | Φ | Φ | Φ | Φ |
| | φ | φ | φ | φ | Φ | φ | ∞ | +∞ | −∞ |
| | ∞ | ∞ | ∞ | ∞ | Φ | ∞ | Φ | Φ | Φ |
| | +∞ | +∞ | +∞ | +∞ | Φ | +∞ | Φ | +∞ | Φ |
| | −∞ | −∞ | −∞ | −∞ | Φ | −∞ | Φ | Φ | −∞ |

Table 4 illustrates an example rules set or a portion thereof. As illustrated, the rules set may include values for an elementary operation such as subtraction.

TABLE 4

| | | A | | | | | | | |
|---|---|---|---|---|---|---|---|---|---|
| | A − B | 0 | 1 | a | Φ | φ | ∞ | +∞ | −∞ |
| B | 0 | 0 | 1 | a | Φ | φ | ∞ | +∞ | −∞ |
| | 1 | −1 | 0 | a − 1 | Φ | φ | ∞ | +∞ | −∞ |
| | b | −b | 1 − b | a − b | Φ | φ | ∞ | +∞ | −∞ |
| | Φ | Φ | Φ | Φ | Φ | Φ | Φ | Φ | Φ |
| | φ | φ | φ | φ | Φ | φ | ∞ | +∞ | −∞ |
| | ∞ | ∞ | ∞ | ∞ | Φ | ∞ | Φ | Φ | Φ |
| | +∞ | −∞ | −∞ | +∞ | Φ | −∞ | Φ | Φ | −∞ |
| | −∞ | +∞ | +∞ | −∞ | Φ | +∞ | Φ | +∞ | Φ |

Table 5 illustrates an example rules set or a portion thereof. As illustrated, the rules set may include values for an elementary operation such as multiplication.

TABLE 5

| | | A | | | | | | | | |
|---|---|---|---|---|---|---|---|---|---|---|
| | A × B | 0 | 1 | n1 | p1 | Φ | φ | ∞ | +∞ | −∞ |
| B | 0 | 0 | 0 | 0 | 0 | Φ | 0 | Φ | Φ | Φ |
| | 1 | 0 | 1 | n1 | p1 | Φ | φ | ∞ | +∞ | −∞ |
| | n2 | 0 | n2 | n1 × n2 | p1 × n2 | Φ | φ | ∞ | −∞ | +∞ |
| | p2 | 0 | p2 | n1 × p2 | p1 × p2 | Φ | φ | ∞ | +∞ | −∞ |
| | Φ | Φ | Φ | Φ | Φ | Φ | Φ | Φ | Φ | Φ |
| | φ | 0 | φ | φ | φ | Φ | φ | Φ | Φ | Φ |
| | ∞ | Φ | ∞ | ∞ | ∞ | Φ | Φ | ∞ | ∞ | ∞ |
| | +∞ | Φ | +∞ | −∞ | +∞ | Φ | Φ | ∞ | +∞ | −∞ |
| | −∞ | Φ | −∞ | +∞ | −∞ | Φ | Φ | ∞ | −∞ | +∞ |

Table 6 illustrates an example rules set or a portion thereof. As illustrated, the rules set may include values for an elementary operation such as division.

TABLE 6

| | | A | | | | | | | | |
|---|---|---|---|---|---|---|---|---|---|---|
| | A/B | 0 | 1 | n1 | p1 | Φ | φ | ∞ | +∞ | −∞ |
| B | 0 | Φ | ∞ | ∞ | ∞ | Φ | Φ | ∞ | ∞ | ∞ |
| | 1 | 0 | 1 | n1 | p1 | Φ | φ | ∞ | +∞ | −∞ |
| | n2 | 0 | 1/n2 | n1/n2 | p1/n2 | Φ | φ | ∞ | −∞ | +∞ |
| | p2 | 0 | 1/p2 | n1/p2 | p1/p2 | Φ | φ | ∞ | +∞ | −∞ |
| | Φ | Φ | Φ | Φ | Φ | Φ | Φ | Φ | Φ | Φ |
| | φ | Φ | Φ | ∞ | ∞ | Φ | Φ | ∞ | ∞ | ∞ |
| | ∞ | 0 | 0 | 0 | 0 | Φ | 0 | Φ | Φ | Φ |
| | +∞ | 0 | 0 | 0 | 0 | Φ | 0 | Φ | Φ | Φ |
| | −∞ | 0 | 0 | 0 | 0 | Φ | 0 | Φ | Φ | Φ |

Table 7 illustrates an example rules set or a portion thereof. As illustrated, the rules set may include values for an elementary operation such as power functions.

TABLE 7

| | | A | | | | | | | | |
|---|---|---|---|---|---|---|---|---|---|---|
| | A\hat{ }B | 0 | 1 | n1 | p1 | Φ | φ | ∞ | +∞ | −∞ |
| B | 0 | Φ | 1 | 1 | 1 | Φ | Φ | Φ | Φ | Φ |
| | 1 | 0 | 1 | n1 | p1 | Φ | φ | Φ | +∞ | −∞ |
| | n2 | ∞ | 1 | n1\hat{ }n2 | p1\hat{ }n2 | Φ | Φ | 0 | 0 | 0 |
| | p2 | 0 | 1 | n1\hat{ }p2 | p1\hat{ }p2 | Φ | φ | ∞ | +∞ | ∞ |
| | Φ | Φ | Φ | Φ | Φ | Φ | Φ | Φ | Φ | Φ |
| | φ | Φ | 1 | φ | φ | Φ | Φ | Φ | Φ | Φ |
| | ∞ | Φ | Φ | Φ | Φ | Φ | Φ | Φ | Φ | Φ |
| | +∞ | 0 | Φ | ∞ | +∞ | Φ | Φ | ∞ | +∞ | ∞ |
| | −∞ | ∞ | 0 | 0 | 0 | Φ | Φ | 0 | 0 | 0 |

As illustrated in Tables 2-7, the specified values for operations on or functions of bounded undefined values, φ, and unbounded undefined values, Φ, may not be the same extended real value. That is, an operation on a bounded undefined value may produce a bounded undefined, a constant or an unbounded value (e.g., φ to the power of a positive number is still φ, 0 time φ is 0, and φ to the power of 0 is Φ). In addition, as illustrated in Tables 2-7, the specified values for operations on positive and negative infinity may produce another (i.e., the same or different) extended real value (e.g., +∞×+∞=+∞ but +∞/+∞=Φ) and/or a real number, such as zero or one (e.g., 1+0×Cos(∞) is 1). A feature of the various systems and processes may be that operations may be continued and/or carried out on extended real values that are received (e.g., from other operations) and a real result may be produced (e.g., a real number such as zero or one). Thus, rather than producing an error message when an extended real value is encountered, continued operations may produce a meaningful result. In addition, operations may not need to be terminated when an extended real value is produced. Furthermore, since some of the results from operations on extended real values may not be critical to the overall operations of an application, continuation of operations on these values may allow operation of an entire system in spite of the existence of extended real values (e.g., as opposed to rules sets that follow IEEE standards that may cause an NaN (an error)).

Another feature of various implementations may include the ability to process badly or ill-formed data due to noise or missing data (e.g., because production of an extended real value during execution of the formulae may not cause termination of the program). Thus, the extended real values processing techniques, may be able to deal with partial and erroneous data. Since approximately similar computations on neighboring data should result in approximately similar values, operations on ill-formed data may not be catastrophically wrong and/or may facilitate improvement of the operations on ill-formed data by postponing decisions on an error to when more information is available. (e.g., applying digital filters to digitized voice may encounter 0/0 but knowing that filtered voice signals should not have undefined values. The undefined values resulted from the application of digital filter can be assigned a meaningful number consistent with the voice pattern such as interpolation between the neighboring numbers.

In addition, because operations may be performed on extended real values, the devices (such as robots containing computers) that implement the operations and their processes may be more damage resistant, since their operations may not be terminated when extended real values are encountered (e.g., when a robot is sent to another planet and its memory unit is damaged during landing, the damaged memory may contain zeros while the operations on zeros such as division by zero can cause errors in traditional computer architecture which would halt the system whereas the new architecture allows for computation or operations on damaged memory). Devices may also be able to machine learn to improve faulty data which may, for example, improve digital rendering of images of geometric objects on computer screens via methods of computational geometry. Since computational geometry involves rotation and translation of objects (e.g., points and lines) which deals with trigonometry functions (e.g., Sin and Cos) and simple arithmetic, computations on ill-formed or missing data can still provide meaningful results (e.g., 0×Cos(0/0)). Operations using extended rules set may not be limited to computational algorithms and can also be useful in other algorithms such as neural networks and genetic algorithms. In addition, operations may also be performed on other types of extended values, as described above.

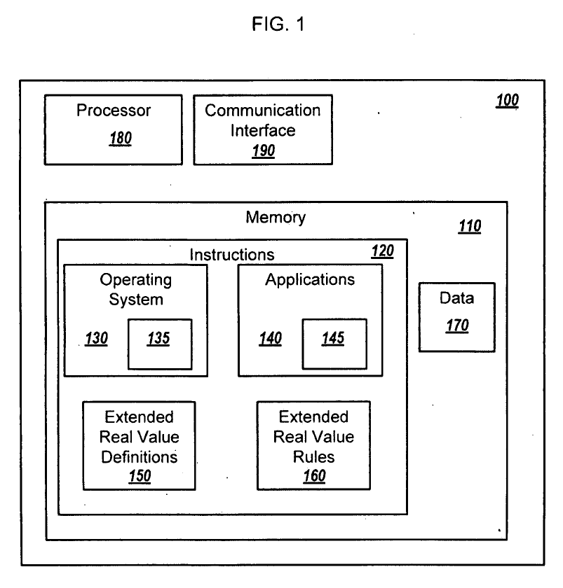

The definition set and rules set may be stored on and/or implemented by various devices. FIG. 1 illustrates an example extended real values processing system. The system illustrated is a portion of a computer 100 that includes a memory 110. The memory 110 includes various instructions 120, such as operating system 130, applications 140, extended real value definitions 150, and extended real value rules 160. In some implementations, the extended real value definitions 150 and/or extended real value rules 160 may be a portion 135 of the operating system 130 and/or a portion 145 of one or more applications 140. The memory 110 may also include other data 170, such as input values, resulting values, intermediate values, and/or any other appropriate data. The computer also includes a processor 180 configured to execute various instructions 120. For example, the processor may be extended to operate an application 140 and/or retrieve various extended real value definitions 150 and/or extended real value rules 160, as desired. The memory may also include a communication interface 190 to facilitate communication with other systems and/or devices (e.g., to retrieve extended real value rules and/or updates to extended real value rules, to obtain input data, to transmit the rules set, definition set, and/or various values obtained from operations, etc.).

During operation, a processor 180 may execute an application 140 that includes a plurality of operations, some of which may included extended real values. The application 140 may utilize inputs from data 170 in the memory 110 and/or may obtain inputs from remote systems through the communication interface. When operations involving extended real values occur, real number definitions 150 and/or rules sets 160 may be retrieved by the processor 180 from the memory 110 to determine the resulting values of the operations. The resulting values may be stored with data 170 in the memory 110 and/or transmitted through the communication interface 190.

Although the system 100 described in FIG. 1 illustrates an implementation, various other implementations may be utilized. Various components and/or operations may be added, deleted and/or modified. For example, the communication interface may not be a part of the portion 100 of the computer. The portion of the computer may be a chip, such as a chip-based processor.

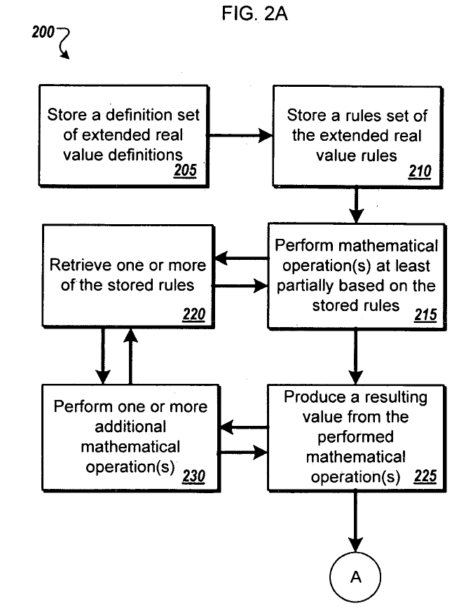

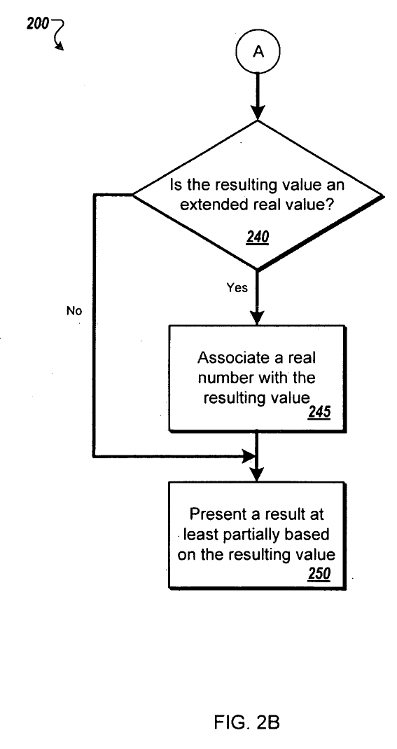

FIGS. 2A-B illustrate an example of extended real value processing 200, which may be performed by systems such as system 100. A definition set of extended real values is stored at 205. For example, in addition to typical real numbers, a set of definitions for positive infinity, negative infinity, unsigned infinity, a bounded undefined real value, and/or an unbounded undefined value may be stored in a memory of a device.

A rules set of the extended real values is stored at 210. For example, values that result from various operations on various extended real values may be specified and stored in a memory of a device.

Mathematical operation(s) are performed at least partially based on the rules at 215. For example, instruction sets (e.g., operating systems, applications, etc.) for various devices may include performing various operations or functions on an input value. As the operations are executed, extended real values may be produced or received (e.g., from operations or as the input value) and the treatment of these extended real values may be at least partially based on the stored rules set. One or more of the stored rules from the rules set are retrieved at 220, for example, as extended real values are encountered in the operations.

A resulting value is produced from the performed mathematical operation(s) at 225 and one or more additional mathematical operation(s) are performed at 230. One or more of the stored rules in the rules set are retrieved at 220, as appropriate, during the execution of the additional mathematical operations.

A determination is made whether the resulting value is an extended real value at 240. If the resulting value is an extended real value, a real number is associated with the resulting value at 245. For example, if the resulting value is positive infinity, the largest number a device can store may be associated with the resulting value. As another example, if the resulting value is negative infinity, the smallest number the device can store may be associated with the resulting value. Note that each extended real value may have a real number representation (typically, least frequently used number) storable by the system. Operations on these “extended” real numbers will follow the extended real value rules set and not the standard arithmetic operations on real numbers.

If the resulting number is not an extended real value and/or when a real number is associated with the resulting number, a result is presented based on the resulting value at 250. By associating a real number with extended real value resulting value, the result may be presented, such as digital images, rather than causing terminal errors in processing data.

As an example, an application may include an operation of 3/x, where x is an input. When the input value for x is zero, an extended real value may be produced. Based on the rules set illustrated in Tables 2-7, the value for this operation is unsigned infinity. If the application then takes the result of the first operation 3/x and multiplies this resulting value by zero, as illustrated in Tables 1 and 5, the specified value of the operation (or resulting value) is an unbounded undefined value. Since this resulting value is an extended real value, an extended real value may be associated with it, and a result (e.g., the result may be a weather map generated based on the result values obtained through the operations of a weather related application) may be generated and/or presented.

Although the process 200 described in FIGS. 2A-B illustrate an implementation, various other implementations may be utilized. Various components and/or operations may be added, deleted and/or modified. For example, a real number may not be associated with resulting values that include extended real values. As another example, the result may be transmitted for presentation to a user.

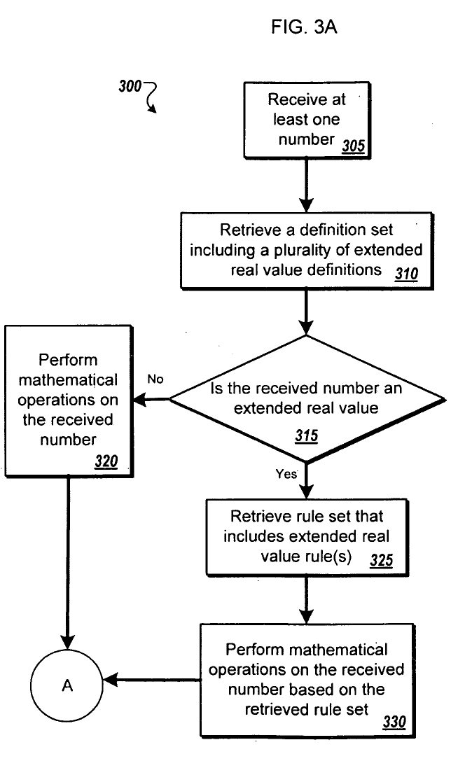

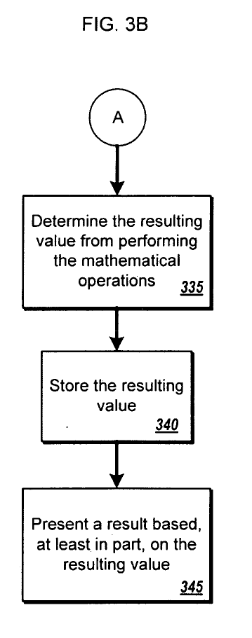

FIGS. 3A-B illustrate an example process 300 for performing operations on extended real values. At least one number is received at 305. For example, an input value may be received and/or a number may be received from other operations. A definition set including a plurality of extended real value definitions is retrieved at 310.

A determination is made whether the received number is an real extended real value at 315. If the received number is not an extended real value, then mathematical operations are performed on the received number (e.g., according to standard computing instruction sets) at 320.

If the received number is an extended real value, then a rules set that includes extended real value rule(s) is retrieved at 325. For example, a rules set may be retrieved from a memory of the device or a remote memory.

Mathematical operations are performed on the received number at least partially based on the retrieved rules at 330. For example, an operation may include a number of steps, one of which may include division by zero. The specified rule for division by zero may be retrieved from the rules set.

The resulting value from the mathematical operations is determined at 335. For example, the specified value for division by zero may be determined.

The resulting value is stored at 340. For example, the resulting value may be stored in the RAM memory of a device for further processing and/or on flash memory associated with the device.

A result at least partially based on the resulting value is presented at 350. For example, the resulting value may be a portion of the information used to provide a result, such as an image. The image to be presented may thus be based at least partially on the resulting value.

Although the process 300 described in FIGS. 3A-B illustrate an implementation, various other implementations may be utilized. Various components and/or operations may be combined, separated, added, deleted and/or modified. For example, the definition set for extended real values may not be retrieved but rather automatically identified by a specified application in use. As another example, the resulting value may be transmitted to another system. As another example, some axioms from real numbers may be utilized with extended real values. For example, axioms dealing with associatively (i.e., A+(B+C)=(A+B)+C), commutatively (A+B=B+A), and/or distributivity (i.e., A×(B+C)=(A×B)+(A×C)) of numbers may apply similarly to real numbers and extended real values

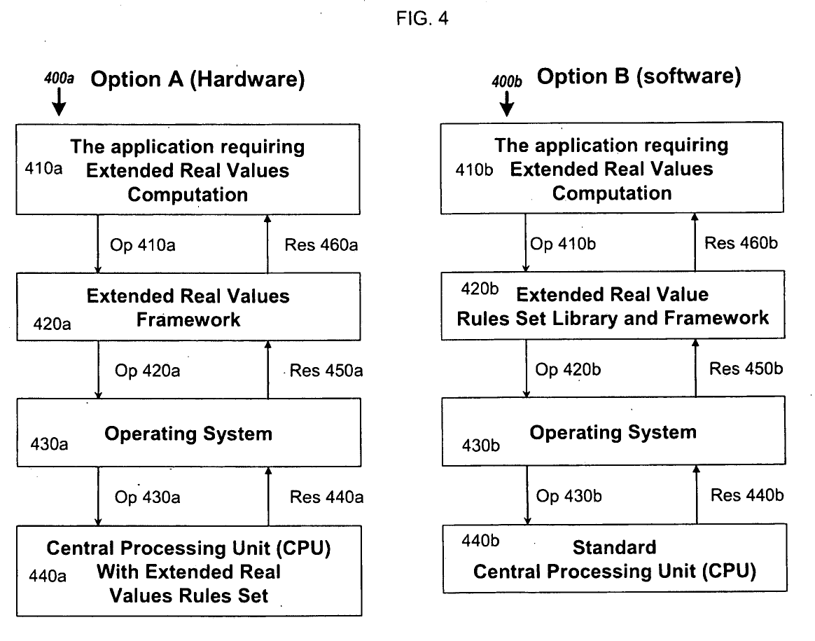

FIG. 4 illustrates a signaling and flow diagram of a process 400 for performing operations using extended real values. There are 2 diagrams: Option A discusses a hardware solution (400a) and option B discusses a software solution (400b). The process 400a can be implemented in a computer, in which an application program 410a may require computation dealing with extended real values, extended real values framework 420a, operating system 430a, and a central processing unit (CPU) 400a which is capable of processing extended real values in hardware. An application may utilize the various other components during execution of the application (e.g., by a processor). During use, when an application program 410 encounters a function that includes at least one extended real value, it may call a framework 420a to handle this equation. In this example, the requested arithmetic operation or equation sent to the framework 420a may be broken down by the framework to simple, atomic operations which are sent to the OS 430a and finally to the CPU 440a. The CPU may perform the atomic operation involving typical real values as well as extended real values using the extended real value rules set and returns the result 440a. The result Res 440a which may include extended real values goes back to the OS 430a and then to the framework 420a. The framework continues sending other atomic operations 420a to the OS and CPU and assembles the result 450b. Additionally, the framework 420a understands the results of the extended real values within various functions and the CPU 440a understands the use of extended real values and the extended real value rules set. Once the equation is completely resolved by the framework, the result 460a goes back to the application requesting the operations. In Option B, a conventional CPU and OS is used but all extended real value operations are handled by a purely software framework containing a library of extended real value functions and operations. This framework understands both the results of the extended real values within various functions, the use of extended real values and the extended real value rules set. In this example, the process 400b can be implemented in a computer, in which an application program 410b requires computation dealing with extended real values. The requested arithmetic operation or equation sent to the framework 420b will be broken down by the framework to simple, atomic operations which are sent to the OS 430b and finally to the CPU 440b. The CPU will perform the atomic, standard real number operation and returns the real number result 440b. The result Res 440a goes back to the OS 430a and then to the framework 420a. The framework analyzes the results and other operations and determine if an extended real value is needed based on the extended real value rules stored in the library. Then it continues sending other atomic real number operations 420a to the OS and CPU and assembles/interpret the result 450b. The main difference between Option A and B is that in Option B, the OS 430b and CPU 440b don't know anything about the extended values and rules and all such operations and decisions are made by the framework 450b. Obviously, Option A is faster because the extended operations are an integral part of the CPU and Option B is easier to implement with conventional CPUs.

Although the implementation 400a and 400b described in FIG. 4 illustrates an implementation, various other implementations may be utilized. Various components and/or operations may be added, deleted and/or modified. For example, an extended real value framework may be a portion of an application program or a portion of a firmware. As another example, although FIG. 4 shows implementation in hardware (CPU) and entirely software library, the example system can be entirely in hardware (CPU), firmware, entirely software library, or combination of those.

Although the described systems, processes, and/or apparatus have been described in specific applications, they may be utilized in a variety of applications. For example, the described systems, processes, and/or apparatus may be utilized in the digital rendering of images of geometrical objects on computer screens via the methods of computational geometry.

As another example, this instruction set may be utilized as a new foundation for CPU processors or computer arithmetic software library to be used in CAD Systems, medical devices, video games and/or many other computational systems. For example, in such systems, geometric transformations involving periodic functions, zeros and infinity may not stop the calculations. In fact, such calculations in some cases can result in a well defined real numbers and/or if the results are still undefined, the decision may be made at the end of computation when more information is available (e.g., setting the unbounded undefined quantity to zero or a large number based on the neighboring quantities which may not have been available when this undefined number was being computed.)

As another example, the described systems, processes, and/or apparatus may be utilized in computational applications such as numerical Fluid Mechanics, Solid Mechanics, Medicine, Radar Images, Remote Sensing, Global Climate Models, etc.

In some implementations, the described systems, processes, and/or apparatus may be utilized in conjunction with a new Instruction Set Architecture for the electronic digital computers. The new instruction set may be utilized, thus, in the domain of computer architecture. Using this architecture, the computer may continue computations in the case of an error (e.g., an extended real value result) and in some cases the results can be a meaningful number (e.g., a real number or number that can be utilized in an application). These instructions (e.g., such as computations in the tables illustrated above and/or additional axioms in the field of arithmetic) and the corresponding quantities (e.g., the symbols for the extended real values in the definition table) may be performed in the CPU of the computer and/or the results may be stored in the CPU, internal/external memory and devices. For example, a 32 bit machine may store plus infinity as the largest real positive number and minus infinity as the largest real negative number while unbounded undefined can be defined a the largest integer positive number and so on. The following are some examples of well-defined results given badly formed data:

y=sin(log(x))*x+5 for x=0 which equates to y=φ*0+5=5.

y=2̂ log(x)+5 for x=0 which equates to y=2̂(−∞)+5=0+5=5.

y=x*log(x−1)+5 for x=0 which equates to y=0*φ+5=0+5=5.

y=x*cos(1/x)+5 for x=0 which equates to y=x*cos(∞)+5=0*φ+5=5.

y=x*cos(x/(x̂2))+5 for x=0 which equates to y=x*cos(Φ)+5=0*φ+5=5.

The above are some examples dealing with extended real values such as infinity, minus infinity, and bounded and unbounded undefined values. There can be many useful examples that are not illustrated here.

A number of implementations have been described. Nevertheless, it will be understood that various modifications may be made without departing from the scope of the invention. Accordingly, other implementations are within the scope of this application.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an”, and “the” include plural referents unless the content clearly indicates otherwise. Thus, for example, reference to “an operation” includes a combination of two or more operations and reference to “an extended real value” includes different types of extended real values.

What is claimed is:

1. A computerized method comprising:
storing a definition set including a plurality of extended real value definitions, wherein an extended real value definition includes a definition for at least one extended real value;
storing a rules set including a plurality of extended real value rules, wherein an extended real value rule specifies a value for a function of at least one of the extended real values; and
performing mathematical operations at least partially based on the stored rules set.

2. The method of claim 1 wherein one or more of the defined extended real values include at least one of positive infinity, negative infinity, unsigned infinity, a bounded undefined value, an unbounded undefined value, a positive bounded undefined value, a negative bounded undefined value, a positive unbounded undefined value, a negative unbounded undefined value, a complex value, an imaginary value, or a bounded undefined value excluding 0.

3. The method of claim 1 wherein the rules set includes values for trigonometric functions of at least one of the defined extended real values.

4. The method of claim 1 wherein the rules set includes values for logarithmic functions of at least one of the defined extended real values.

5. The method of claim 1 wherein the rules set includes values for power functions of at least one of the defined extended real values.

6. The method of claim 1 wherein the rules set includes values for at least one elementary function of at least one of the defined extended real values.

7. The method of claim 1 wherein performing mathematical operations at least partially based on the stored rules set produces a resulting value, the method further comprising storing the resulting value.

8. The method of claim 7 wherein the resulting value comprises a real number.

9. The method of claim 7 wherein the resulting value comprises an extended real value, and further comprising associating a real number with the resulting value.

10. The method of claim 1 wherein the mathematical operations comprise:
at least one first function that includes an operation on at least one extended real value and produces a first resulting value; and
at least one second function that includes an operation on the first resulting value, wherein at least one of the extended real value rules is defined such that the second function operates on the first resulting value.

11. The method of claim 1 wherein the definition set and the rules set facilitate continued operations of a device after computations produce an extended real value.

12. An article comprising a machine-readable medium storing instructions, the instructions operable to cause data processing apparatus to perform operations comprising:
receiving at least one extended real value;
retrieving a definition set including a plurality of extended real value definitions, wherein an extended real value definition includes a definition for at least one defined extended real value;
retrieving one or more rules from a rules set, wherein the rules set includes a plurality of extended real value rules, and wherein an extended real value rule includes a value for a function of at least one of the extended real values; and
performing mathematical operations at least partially based on the retrieved rules set.

13. The article of claim 12 wherein one or more of the defined extended real values include at least one of positive infinity, negative infinity, unsigned infinity, a bounded undefined value, an unbounded undefined value, a positive bounded undefined value, a negative bounded undefined value, a positive unbounded undefined value, a negative unbounded undefined value, a complex value, an imaginary value, or a bounded undefined value excluding 0.

14. The article of claim 12 wherein the rules set includes at least one of values for trigonometric functions of one or more of the defined extended real values, values for logarithmic functions of one or more of the defined extended real values, values for power functions of one or more of the defined extended real values, or values for at least one elementary function of one or more of the defined extended real values.

15. The method of claim 12 wherein the instructions are further operable to cause data processing apparatus to perform operations comprising:
receiving a number;
determining if the received number is an extended real value based on at least one of the retrieved definitions in the definition set; and
performing mathematical operations at least partially based on the retrieved rules set, if the value is an extended real value.

16. A system for processing data comprising:
a memory storing:
a definition set including a plurality of extended real value definitions, wherein an extended real value definition includes a definition for at least one defined extended real value; and
a rules set including a plurality of extended real value rules, wherein an extended real value rule includes a value for a function of at least one of the extended real values; and
a processor adapted to performing mathematical operations at least partially based on the stored rules set.

17. The system of claim 16 wherein one or more of the defined extended real values include at least one of positive infinity, negative infinity, unsigned infinity, a bounded undefined value, an unbounded undefined value, a positive bounded undefined value, a negative bounded undefined value, a positive unbounded undefined value, a negative unbounded undefined value, a complex value, an imaginary value, or a bounded undefined value excluding 0.

18. The article of claim 16 wherein the rules set includes at least one of values for trigonometric functions of at least one of the defined extended real values, values for logarithmic functions of at least one of the defined extended real values, values for power functions of at least one of the defined extended real values, values for at least one elementary function of at least one of the defined extended real values.

19. The system of claim 16 wherein performing mathematical operations at least partially based on the stored rules set produces a resulting value; and wherein the memory stores the resulting value.

20. The method of claim 19 wherein the resulting value comprises a real number.

21. The method of claim 19 wherein the resulting value comprises an extended real value, and further comprising associating a real number with the resulting value.
